(19) United States
(12) Patent Application Publication
(10) Pub. No.: US 2022/0118798 A1
(43) Pub. Date: Apr. 21, 2022

(54) TIRE

(71) Applicant: SUMITOMO RUBBER INDUSTRIES, LTD., Hyogo (JP)

(72) Inventor: Koki NAGASAWA, Hyogo (JP)

(73) Assignee: SUMITOMO RUBBER INDUSTRIES, LTD., Hyogo (JP)

(21) Appl. No.: 17/494,112

(22) Filed: Oct. 5, 2021

(30) Foreign Application Priority Data
Oct. 20, 2020 (JP) 2020-176231

(51) Int. Cl. B60C 11/03

(52) U.S. Cl. CPC B60C 11/0309; B60C 11/0304; B60C 2011/0365; B60C 2011/036; B60C 2011/0388; B60C 2011/0341

(57) ABSTRACT

The tire includes a tread portion having a plurality of circumferential grooves and land regions. The land regions include a crown land region and a first middle land region. The crown land region has a plurality of crown lateral grooves. The first middle land region has a plurality of first middle lateral grooves. In a tread plan view, an angle between a first linear line connecting both ends of each of the crown lateral grooves and a second linear line connecting both ends of a respective one of the first middle lateral grooves is 90 degrees or more and 150 degrees or less. Each of the crown lateral grooves includes a first end portion, a second end portion, and a center portion. The center portion has a groove width smaller than a groove width of the first end portion and a groove width of the second end portion.

### TECHNICAL FIELD

The present disclosure relates to a tire.

### BACKGROUND ART

Patent Document 1 listed below has proposed a tire having a center land region and middle land regions provided with a plurality of lateral grooves. The above-described tire is expected to improve steering stability while suppressing decrease in on-ice/on-snow performance by these lateral grooves.

### PRIOR ART DOCUMENT

### Patent Document

[Patent Document 1]

Japanese Unexamined Patent Application Publication No. 2017-056814

### SUMMARY OF THE INVENTION

### Problems to be Solved by the Invention

In general, there is a tendency in tires designed for running on snow that the tread portion is provided with circumferential grooves extending continuously in a tire circumferential direction and lateral grooves inclined with respect to a tire axial direction. During running on snowy roads, the above tire compresses the snow in the circumferential grooves and the lateral grooves and shears the compressed snow to generate snow shearing force to ensure on-snow performance.

In order to increase the snow shearing force, the number of intersections between the circumferential grooves and the lateral grooves can be increased, or the volume of these grooves can be increased. However, it is possible that such methods lead to deterioration of noise performance. On the other hand, in recent years, the level of demand for tire performance has been increasing, and even tires designed for running on snowy roads are required to have improved noise performance.

The present disclosure was made in view of the above, and a primary object thereof is to provide a tire having improved noise performance while maintaining the on-snow performance.

### Means for Solving the Problems

The present disclosure is a tire including a tread portion, wherein the tread portion includes a plurality of circumferential grooves extending continuously in a tire circumferential direction between a first tread edge and a second tread edge, and a plurality of land regions demarcated by the circumferential grooves, the land regions include a crown land region and a first middle land region adjacent to the crown land region on the first tread edge side with one of the circumferential grooves therebetween, the crown land region is provided with a plurality of crown lateral grooves inclined to a first side with respect to a tire axial direction and completely cross the crown land region in the tire axial direction, the first middle land region is provided with a plurality of first middle lateral grooves inclined to a second side opposite to the first side with respect to the tire axial direction and completely cross the first middle land region in the tire axial direction, in a tread plan view, an angle between a first linear line connecting both ends of each of the crown lateral grooves and a second linear line connecting both ends of a respective one of the first middle lateral grooves is 90 degrees or more and 150 degrees or less, each of the crown lateral grooves includes a first end portion and a second end portion in the tire axial direction, and a center portion arranged between the first end portion and the second end portion, and the center portion has a groove width smaller than a groove width of the first end portion and a groove width of the second end portion.

### Effects of the Invention

By adopting the above configuration, the tire of the present disclosure can improve the noise performance while maintaining the on-snow performance.

### BRIEF DESCRIPTION OF THE DRAWINGS

FIG. 1 a development view of a tread portion of a tire according to an embodiment of the present disclosure.

FIG. 2 an enlarged view of a crown land region and a first middle land region of FIG. 1.

FIG. 3 an enlarged view of one of crown lateral grooves and one of first middle lateral grooves of FIG. 2.

FIG. 4 a lateral cross-sectional view of the crown land region.

FIG. 5 an enlarged view of a second middle land region of FIG. 1.

FIG. 6 an enlarged view of a first shoulder land region of FIG. 1.

FIG. 7 an enlarged view of a second shoulder land region of FIG. 1.

FIG. 8 an enlarged view of the crown land region and the first middle land region of Reference.

### MODE FOR CARRYING OUT THE DISCLOSURE

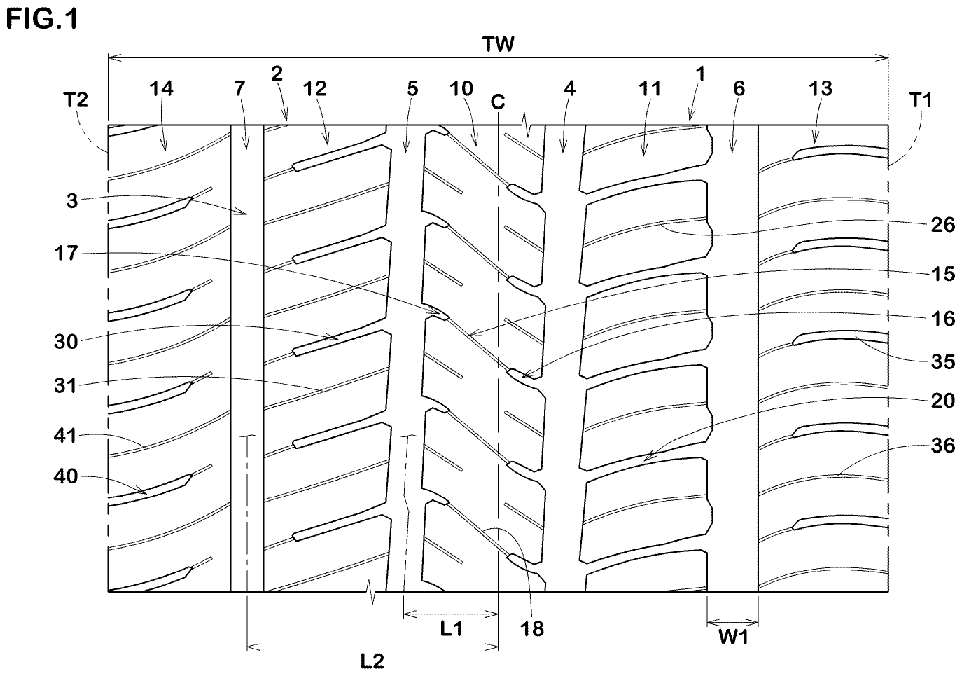

An embodiment of the present disclosure will now be described in conjunction with accompanying drawings. FIG. 1 is a development view of a tread portion 2 of a tire 1 according to the present embodiment. As shown in FIG. 1, the tire 1 of the present embodiment is used as a pneumatic tire for passenger cars intended for use in winter, for example. However, the tire 1 of the present disclosure is not limited to such an embodiment.

The tire 1 of the present embodiment has a tread portion 2 whose position when mounted on a vehicle is specified, for example. The mounting position on a vehicle is indicated by letters or marks on a sidewall portion (not shown), for example. The tread portion 2 is configured to have an asymmetric pattern (meaning that the tread pattern is not line-symmetric with respect to a tire equator (C)), for example.

The tread portion 2 includes a first tread edge T1 to be positioned on an inner side of the vehicle when mounted thereon, and a second tread edge T2 to be positioned on an outer side of the vehicle when mounted thereon. The first tread edge T1 and the second tread edge T12 are axially outermost ground contacting positions of a ground contacting surface of the tire 1 when the tire 1 in a standard state is in contact with a flat surface with zero camber angle by being loaded with a standard tire load.

The term “standard state” means a state in which the tire 1 is mounted on a standard rim (not shown), inflated to a standard inner pressure, and loaded with no tire load. In the case of tires for which various standards are not specified, or non-pneumatic tires, the above standard state means the standard operating state depending on the intended use of the tires loaded with no tire load. In the present specification, unless otherwise noted, the dimensions and the like of various parts of the tire are the values measured in the standard state described above.

The “standard rim” is a wheel rim specified for the concerned tire by a standard included in a standardization system on which the tire is based, for example, the “normal wheel rim” in JATMA, “Design Rim” in TRA, and “Measuring Rim” in ETRTO.

The “standard inner pressure” is an air pressure specified for the concerned tire by a standard included in a standardization system on which the tire is based, for example, the maximum air pressure in JATMA, maximum value listed in the “TIRE LOAD LIMITS AT VARIOUS COLD INFLATION PRESSURES” table in TRA, and “INFLATION PRESSURE” in ETRTO.

The “standard tire load” is a tire load specified for the concerned tire by a standard included in a standardization system on which the tire is based, for example, the “maximum load capacity” in JATMA, maximum value listed in “TIRE LOAD LIMITS AT VARIOUS COLD INFLATION PRESSURES” table in TRA, and “LOAD CAPACITY” in ETRTO. Further, in the case of tires for which various standards are not specified, or non-pneumatic tires, the term “standard tire load” refers to the load applied to a single tire under a standard tire mounting condition. The “standard tire mounting condition” refers to a condition in which the tires are mounted on a standard vehicle according to the intended use of the tires and the vehicle is stationary on a flat road surface in a roadworthy condition.

The tread portion 2 includes a plurality of circumferential grooves 3 extending continuously in the tire circumferential direction between the first tread edge T1 and the second tread edge T2, and a plurality of land regions demarcated by the circumferential grooves 3. The tire 1 of the present embodiment is configured as a so-called 5-rib tire in which the tread portion 2 includes five land regions demarcated by four circumferential grooves 3. However, the present disclosure is not limited to such an embodiment, it can be a so-called four-rib tire in which the tread portion 2 has three circumferential grooves 3 and four land regions, for example.

The circumferential grooves 3 include a first crown circumferential groove 4, a second crown circumferential groove 5, a first shoulder circumferential groove 6, and a second shoulder circumferential groove 7, for example. The first crown circumferential groove 4 is arranged between the tire equator (C) and the first tread edge T1. The second crown circumferential groove 5 is arranged between the tire equator (C) and the second tread edge 12. The first shoulder circumferential groove 6 is arranged between the first crown circumferential groove 4 and the first tread edge T1. The second shoulder circumferential groove 7 is arranged between the second crown circumferential groove 5 and the second tread edge T2.

The circumferential grooves 3 can be various forms such as grooves extending linearly or in a zigzag manner in the tire circumferential direction.

A distance L1 in the tire axial direction from a groove centerline of the first crown circumferential groove 4 or the second crown circumferential groove 5 to the tire equator (C) is 5% or more and 15% or less of a tread width TW, for example. A distance L2 in the tire axial direction from a groove centerline of the first shoulder circumferential groove 6 or the second shoulder circumferential groove 7 to the tire equator (C) is 25% or more and 35% or less of the tread width TW, for example. The tread width TW is the distance in the tire axial direction from the first tread edge T1 to the second tread edge T2 in the standard state.

It is preferred that a groove width W1 of each of the circumferential grooves 3 is at least 3 mm or more. In a preferred embodiment, the groove width W1 of each of the circumferential grooves 3 is 3.0% or more and 7.0% or less of the tread width TW.

The land regions include at least a crown land region 10 and a first middle land region 11. The crown land region is demarcated between the first crown circumferential groove 4 and the second crown circumferential groove 5. The first middle land region 11 is demarcated between the first crown circumferential groove 4 and the first shoulder circumferential groove 6, and is adjacent to the crown land region 10 with the first crown circumferential groove 4 therebetween.

Further, in addition to these, the land regions of the present embodiment include a second middle land region 12, a first shoulder land region 13, and a second shoulder land region 14. The second middle land region 12 is demarcated between the second crown circumferential groove 5 and the second shoulder circumferential groove 7, and is adjacent to the crown land region 10 with the second crown circumferential groove 5 therebetween. The first shoulder land region 13 is demarcated axially outside the first shoulder circumferential groove 6 and includes the first tread edge T1. The second shoulder land region 14 is demarcated axially outside the second shoulder circumferential groove 7 and includes the second tread edge T2.

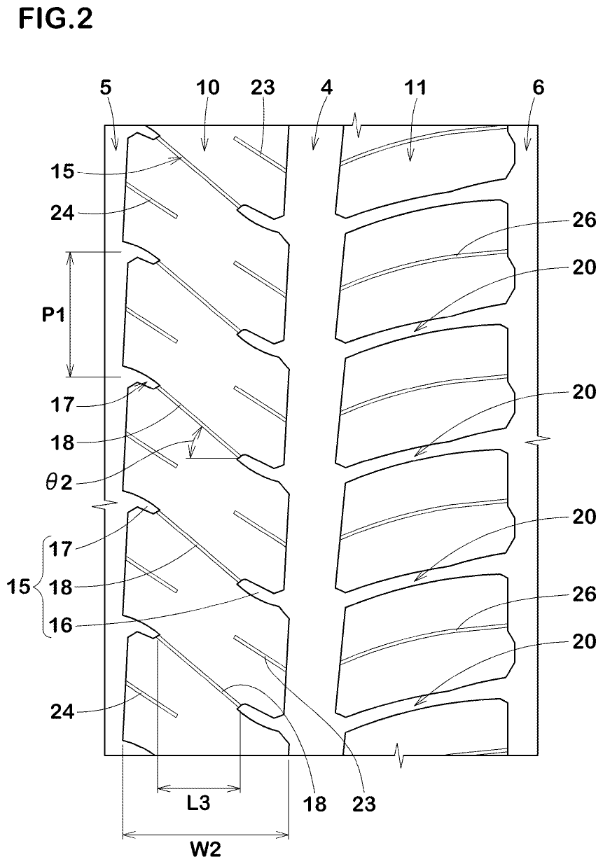

FIG. 2 shows an enlarged view of the crown land region 10 and the first middle land region 11. As shown in FIG. 2, the crown land region 10 is provided with a plurality of crown lateral grooves 15. Each of the crown lateral grooves 15 is inclined to a first side (down to the right in each Figure of the present specification) with respect to the tire axial direction and completely crosses the crown land region 10 in the tire axial direction. The first middle land region 11 is provided with a plurality of first middle lateral grooves 20. Each of the first middle lateral grooves 20 is inclined to a second side (up to the right in each Figures of the present specification), which is opposite to the first side, with respect to the tire axial direction and completely crosses the first middle land region 11 in the tire axial direction.

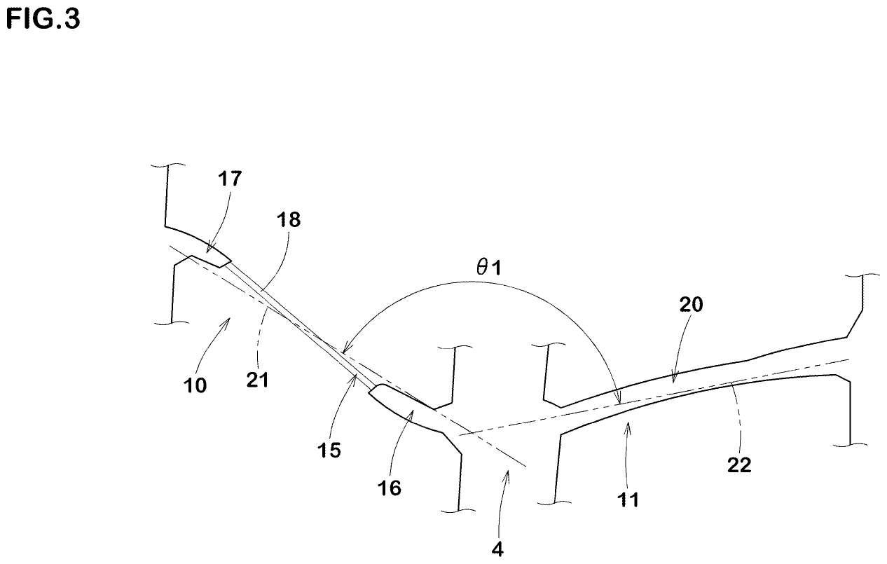

FIG. 3 shows an enlarged view of one of the crown lateral grooves 15 and one of the first middle lateral grooves 20. As shown in FIG. 3, in a tread plan view, an angle θ1 between a first linear line 21 connecting both ends of the crown lateral groove and a second linear line 22 connecting both ends of the first middle lateral grooves 20 is 90 degrees or more and 150 degrees or less.

Further, each of the crown lateral grooves 15 includes a first end portion 16 and a second end portion 17 in the tire axial direction, and a center portion 18 arranged between the first end portion 16 and the second end portion 17. In each of the crown lateral grooves 15, a groove width of the center portion 18 is smaller than a groove width of the first end portion 16 and a groove width of the second end portion 17. By adopting the above configuration, the tire 1 of the present disclosure can improve the noise performance while maintaining the on-snow performance. The following mechanisms can be inferred as reasons for this.

The crown lateral grooves 15 and the first middle lateral grooves 20 of the present disclosure are inclined to opposite sides to each other, therefore, a large snow shearing force is generated in multiple directions when running on snowy roads, thereby, the on-snow performance can be improved. In addition, in the present disclosure, the angle θ1 between the first linear line 21 and the second linear line 22 described above is defined as above, therefore it is possible that resonance of noise generated by the crown lateral grooves 15 and first middle lateral grooves 20 is suppressed while the on-snow performance is improved. In other words, the above-mentioned configuration can disperse the frequency band of the noise generated by the crown lateral grooves 15 and the first middle lateral grooves 20 to turn the noise into white noise.

Furthermore, each of the crown lateral grooves 15 includes the center portion 18 having a smaller groove width, therefore, the amount of air passing through each of the crown lateral grooves 15 can be decreased, thereby, the noise generated in the crown lateral grooves 15 is decreased. In addition, the resonance described above can be suppressed more effectively. It is inferred that the present disclosure can improve the noise performance while maintaining the on-snow performance through such mechanisms.

The more detailed configurations of the present embodiment will now be described below. It should be noted that each of the configurations described below represents a specific form of the present embodiment. Therefore, it goes without saying that the present disclosure can exert the above-mentioned effects even if it does not have the configurations described below. Further, even if any one of the configurations described below is applied alone to the tire of the present disclosure with the above-mentioned features, the performance can be expected to be improved according to each configuration. In addition, when some of the configurations described below are applied in combination, the combined performance improvement can be expected according to each of the applied configurations.

As shown in FIG. 2, a maximum groove width of the center portion 18 of each of the crown lateral grooves 15 is 15% or less, and preferably 3% or more and 15% or less, of a maximum groove width of each of the first end portion 16 and the second end portion 17, for example. As a more preferred embodiment, the center portion 18 of each of the crown lateral grooves of the present embodiment is configured as a narrow groove portion having the groove width of 1.5 mm or less. Thereby, rigidity of the crown land region 10 can be maintained, therefore, the steering stability on dry roads (hereinafter may be referred to simply as “steering stability”) is improved. In the following, unless otherwise noted, the term “narrow groove portion” refers to a portion of a groove where the groove width is 1.5 mm or less. Further, the term “narrow groove” refers to a groove having a groove width of 1.5 mm or less in its entirety. Furthermore, a groove not described as a narrow groove has a groove width greater than 1.5 mm. In each of the lateral grooves of the present embodiment, the portion not marked as a narrow groove portion has a groove width of 2.0 mm or more and 4.0 mm or less, for example.

Each of the center portions 18 crosses the center position in the tire axial direction of the crown land region, for example. Each of the center portions 18 has a length L3 of 40% or more and 60% or less of a width W2 in the ire axial direction of the crown land region 10, for example. The center portions 18 configured as such improve the on-snow performance and the noise performance in a good balance.

Each of the center portions 18 is inclined to the first side with respect to the tire axial direction. Each of the center portions 18 has an angle 92 of 45 degrees or less, preferably 35 degrees or more and 45 degrees or less, with respect to the tire axial directions, for example.

Each of an axial length of each of the first end portions 16 and an axial length of each of the second end portions 17 is smaller than the axial length L3 of each of the center portions 18, and 20% or more and 30% or less of the axial width W2 of the crown land region 10.

The first end portions and the second end portions are inclined to the first side with respect to the tire axial direction. Further, each of the first end portions 16 and the second end portions 17 has an angle with respect to the tire axial direction smaller than the angle 92 of each of the center portions 18 with respect to the tire axial direction, for example, 10 degrees or more and-25 degrees or less. Thereby, it is preferred that each of the crown lateral grooves 15 includes a portion consisting of the first end portion 16 and the center portion 18 and slightly convex toward one side in the tire circumferential direction, and a portion consisting of the second end portion 17 and the center portion 18 and slightly convex toward the other side in the tire circumferential direction. The crown lateral grooves 15 configured as such form hard snow blocks by the first end portion 16 and the second end portion 17 together with the circumferential grooves, and thus can improve traction performance on snow.

As shown in FIG. 3, by the above configuration of the crown lateral grooves, an angle with respect to the tire axial direction of the first linear line 21 connecting both ends of each of the crown lateral grooves 15 is, for example, 45 degrees or less, and preferably 20 degrees or more and 40 degrees or less.

One pitch length P1 in the tire circumferential direction of the crown lateral grooves 15 is 60% or more and 90% or less of the width W2 in the tire axial direction of the crown land region 10, for example. Therefore, the on-snow performance and the noise performance are improved in a good balance.

Between two crown lateral grooves 15 adjacent to each other in the tire circumferential direction, a first crown narrow groove 23 and a second crown narrow groove 24 are provided. The first crown narrow groove 23 extends from the first crown circumferential groove 4 and terminates to have a closed end within the crown land region 10. The second crown narrow groove 24 extends from the second crown circumferential groove 5 and terminates to have a closed end within the crown land region 10.

The first crown narrow groove 23 has an axial length of 80% or more and 120% or less of an axial length of the first end portion 16 of each of the crown lateral grooves 15, for example. Further, the second crown narrow groove 24 terminates on the first crown circumferential groove 4 side of the second end portion 17 of each of the crown lateral grooves 15, for example. The first crown narrow grooves 23 and the second crown narrow grooves 24 configured as such disperse the frequency of noise generated when the crown land region 10 comes into contact with the ground, therefore, the noise performance is improved.

The first crown narrow grooves 23 and the second crown narrow grooves 24 are inclined to the first side with respect to the tire axial direction. An angle of each of the first crown narrow grooves 23 with respect to the tire axial direction and an angle of each of the second crown narrow grooves 24 with respect to the tire axial direction are each smaller than the angle of the center portion 18 of each of the crown lateral grooves 15 with respect to the tire axial direction. On the other hand, an angle difference between the angle of the first crown narrow groove 23 and the second crown narrow groove 24 and the angle of the center portion 18 is 15 degrees or less, and preferably 10 degrees or less, for example. Specifically, the first crown narrow grooves 23 and the second crown narrow grooves 24 are inclined at an angle of 30 degrees or more and 40 degrees or less with respect to the tire axial direction.

It is preferred that a rand ratio of the crown land region 10 is 65% or more and 75% or less. Therefore, the on-snow performance and the steering stability are improved in a good balance. It should be noted that in the present specification, the term “land ratio” of a land region refers to a ratio of the area of the actual ground contacting surface of the land region relative to the area of a virtual ground contacting surface obtained by filling all the grooves provided in the land region.

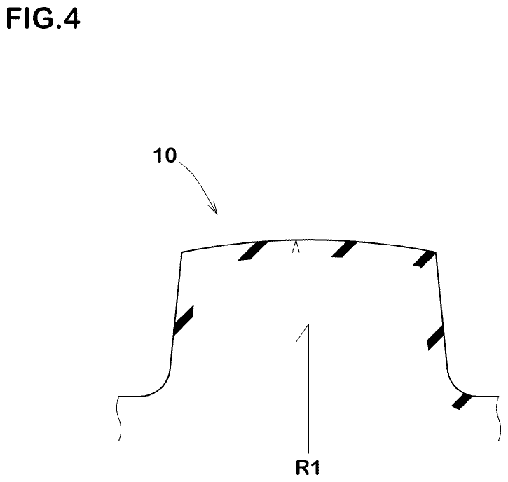

FIG. 4 shows a lateral cross-sectional view of the crown land region 10. As shown in FIG. 4, in a meridian section passing through a tire rotational axis of the tire in the standard state in which the tire is mounted on the standard rim, inflated to the standard inner pressure, and loaded with no tire load, a ground contacting surface of the crown land region 10 has a profile curved so as to be convex radially outwardly. Further, the profile of the ground contacting surface of the crown land region 10 has a radius of curvature RI of 350 mm or more and 500 mm or less, for example. The crown land region 10 configured as such moderates ground contact pressure applied to longitudinal edges extending in the tire circumferential direction at the edges of the land region, and thus can improve the noise performance while maintaining the on-snow performance. It should be noted that it goes without saying that in FIG. 4, the curvature of the aforementioned profile is depicted larger than the real one, so that the above-mentioned features can be easily understood.

As shown in FIG. 3, each of the first middle lateral grooves is curved so as to be convex toward one side in the tire circumferential direction. However, in each of the first middle lateral grooves 20, the curvature of the first middle lateral groove 20 is slight, and a distance between a groove center line of the first middle lateral groove 20 and the second linear line 22 connecting both ends of the first middle lateral groove 20 is smaller than a groove width of the first middle lateral groove 20. Further, in each of the first middle lateral grooves 20, a center portion in a longitudinal direction thereof has a groove width smaller than each of groove widths of both end portions. In the first middle lateral grooves 20 configured as such, the groove shapes easily deform according to changes in the ground contact pressure applied to the grooves, therefore, snow can be compressed hard in the grooves as well as clogging of snow in the grooves can be suppressed.

The first middle lateral grooves 20 are arranged at an angle different from an angle of the crown lateral grooves 15 with respect to the tire axial direction. Thereby, resonance of the noise generated by each of the lateral grooves can be surely prevented. In the present embodiment, the second linear line 22 has an angle with respect to the tire axial direction smaller than an angle of the first linear line 21 with respect to the tire axial direction. The angle of the second linear line 22 with respect to the tire axial direction is 5 degrees or more and 25 degrees or less, for example. The first middle lateral grooves 20 configured as such are helpful for further improving the noise performance.

In the present embodiment, each of the crown lateral grooves 15 and a respective one of the first middle lateral grooves 20 are adjacent to each other in the tire axial direction, so that each of the first linear lines 21 and a respective one of the second linear lines 22 intersect in the first crown circumferential groove 4 arranged between the crown land region 10 and the first middle land region 11 in the tread plan view. In a more preferred embodiment, in a pair of the crown lateral groove 15 and the first middle lateral groove 20 adjacent to each other, an area obtained by projecting a connection portion between the crown lateral groove 15 and the first crown circumferential groove 4 parallel to the tire axial direction overlaps with a connection portion between the first middle lateral groove 20 and the first crown circumferential groove 4. In a more desirable form, as shown in FIG. 2, each pair of the crown lateral groove 15 and the first middle lateral groove 20 adjacent to each other in the tire circumferential direction is arranged according to the relationship described above. As a result, the crown lateral grooves 15 and the first middle lateral grooves 20 can form hard snow blocks in the connection portions with the first crown circumferential groove 4, therefore, excellent on-snow performance can be exerted.

The first middle land region 11 of the present embodiment is provided with a plurality of first middle narrow grooves 26. Each of the first middle narrow grooves 26 completely crosses the first middle land region 11 in the tire axial direction and the first middle narrow grooves 26 and the first middle lateral grooves 20 are arranged alternately one by one in the tire circumferential direction.

The first middle narrow grooves 26 are inclined to the second side with respect to the tire axial direction, for example. Each of the first middle lateral grooves 20 of the present embodiment extends along a respective one of the first middle lateral grooves 20, and an angle difference between these grooves is set to be 5 degrees or less. Further, the first middle narrow grooves 26 are arranged at an angle smaller than the first crown narrow grooves 23 and the second crown narrow grooves 24 with respect to the tire axial direction. Specifically, the angle of each of the first middle narrow grooves 26 with respect to the tire axial direction is 5 degrees or more and 25 degrees or less.

The first middle land region 11 has the land ratio of 65% or more and 75% or less, for example. In a preferred embodiment, the land ratio of the first middle land region 11 is greater than the land ratio of the crown land region 10. Thereby, the steering stability is improved while the on-snow performance is maintained.

The ground contacting surface of the first middle land region 11 has a profile curved so as to be convex radially outward, similar to the ground contacting surface of the crown land region 10 shown in FIG. 4. It is preferred that a radius of curvature of the ground contacting surface of the first middle land region 11 is smaller than the radius of curvature of the ground contacting surface of the crown land region 10, and for example, 250 mm or more and 300 mm or less. The first middle land region 11 configured as such moderates the ground contact pressure applied to the longitudinal edges thereof and thus can improve the noise performance while maintaining the on-snow performance.

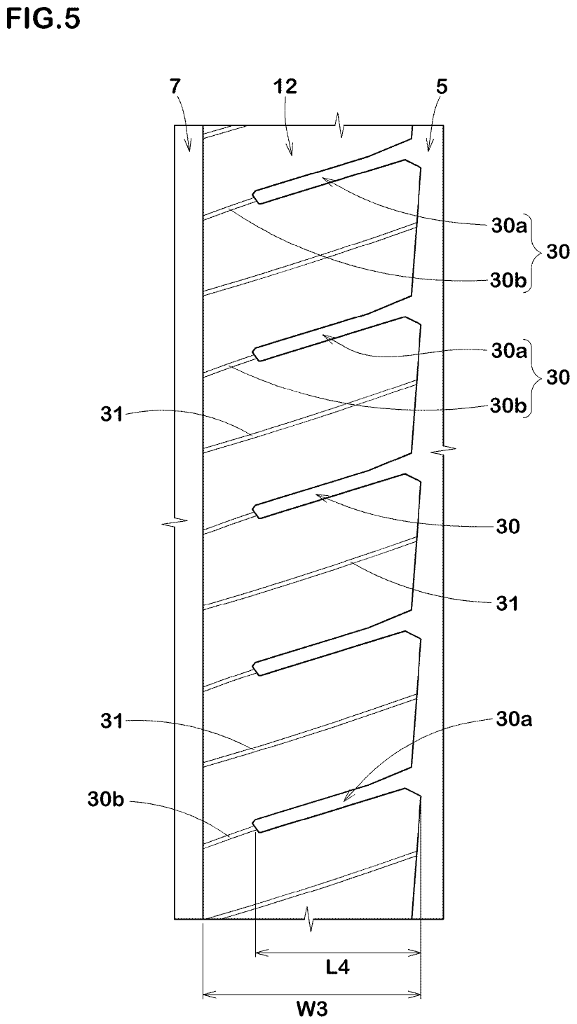

FIG. 5 shows an enlarged view of the second middle land region 12. As shown in FIG. 5, the second middle land region 12 is provided with a plurality of second middle lateral grooves 30 and second middle narrow grooves 31 arranged alternately one by one in tire circumferential direction.

The second middle lateral grooves 30 are inclined to the second side with respect to the tire axial direction and each completely crosses the second middle land region 12 in the tire axial direction, for example. It is preferred that the second middle lateral grooves are arranged at an angle with respect to the tire axial direction smaller than the center portions 18 of the crown lateral grooves 15 (shown in FIG. 2). The angle of each of the second middle lateral grooves 30 with respect to the tire axial direction is 15 degrees or more and 25 degrees or less, for example. Thereby, the resonance of the noise generated by the second middle lateral grooves 30 and the crown lateral grooves 15 can be suppressed.

Each of the second middle lateral grooves 30 includes an inner groove portion (30a) extending from the second crown circumferential groove 5, and an outer narrow groove portion (30b) extending from an axially outer end of the inner groove portion (30a) to the second shoulder circumferential groove 7, for example.

The inner groove portion (30a) crosses a center position in the tire axial direction of the second middle land region 12, for example. The inner groove portion (30a) has a length IA in the tire axial direction of 60% or more and 90% or less of a width W3 in the tire axial direction of the second middle land region 12, for example. The inner groove portions (30a) configured as such improve the on-snow performance and the steering stability in a good balance.

In the present embodiment, it is preferred that a projected area obtained by extending each of the inner groove portions (30a) along a longitudinal direction thereof overlaps the connection portion between the second crown circumferential groove 5 and a respective one of the crown lateral grooves 15 (shown in FIG. 2). Therefore, the on-snow performance is further improved.

The outer narrow groove portion (30b) is inclined to the second side and extends linearly from the inner groove portion (30a) to the second shoulder circumferential groove 7, for example.

Each of the second middle narrow grooves 31 is inclined to the second side with respect to the tire axial direction and completely crosses the second middle land region 12 in the tire axial direction, for example. Each of the second middle narrow grooves 31 of the present embodiment extends along a respective one of the second middle lateral grooves 30, and an angle difference between them is set to be 5 degrees or less, for example. The second middle narrow grooves configured as such can improve the on-snow performance while suppressing uneven wear in the second middle land region 12.

The second middle lateral grooves 30 has the land ratio of 65% or more and 75% or less, for example. In a preferred embodiment, the land ratio of the first middle land region 11 is greater than the land ratio of the crown land region 10. Further, the ground contacting surface of the second middle land region 12 has a profile curved so as to be convex outward in the tire radial direction, similar to the ground contacting surface of the crown land region 10 shown in FIG. 4. A radius of curvature of the ground contacting surface of the second middle land region 12 is the same as that of the first middle land region 11, and for example, 250 mm or more and 300 mm or less.

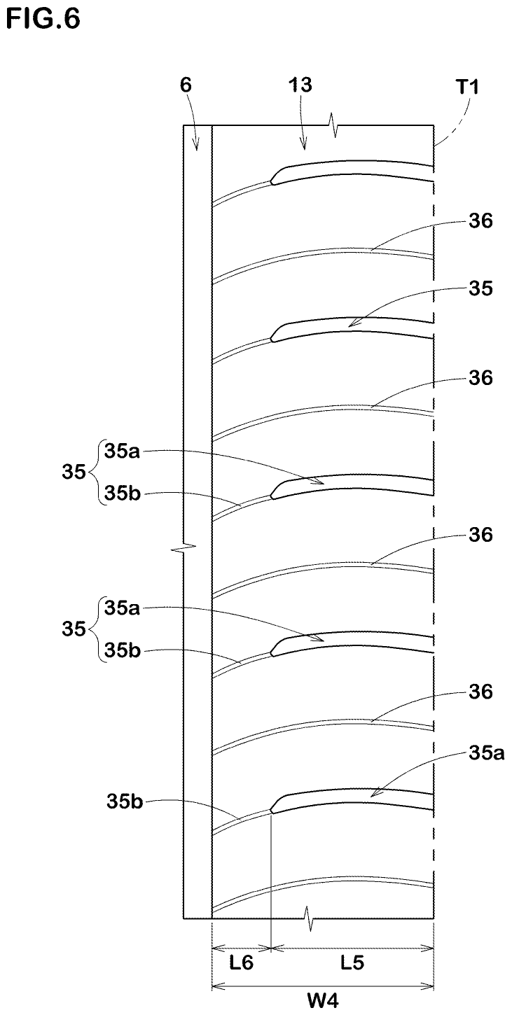

FIG. 6 shows an enlarged view of the first shoulder land region 13. As shown in FIG. 6, the first shoulder land region 13 is provided with first shoulder lateral grooves 35 and first shoulder narrow grooves 36 arranged alternately one by one in the tire circumferential direction.

Each of the first shoulder lateral grooves extends at least from the first tread edge T1 to the first shoulder circumferential groove 6, for example. Each of the first shoulder lateral grooves 35 are curved so as to be convex toward one side in the tire circumferential direction, for example.

Each of the first shoulder lateral grooves 35 includes a main body portion (35a) arranged on the first tread edge T1 side and an inner end portion (35b) extending from an axially inner end of the main body portion (35a) to the first shoulder circumferential groove 6.

The main body portion (35a) of each of the first shoulder lateral grooves 35 crosses a center position in the tire axial direction of the first shoulder land region 13, for example. The main body portion (35a) has a length L5 in the tire axial direction of 60% or more and 80% or less of a width W4 in the tire axial direction of the first shoulder land region 13, for example. Thereby, the on-snow performance and the noise performance are improved in a good balance.

The inner end portion (35b) has a groove width smaller than a groove width of the main body portion (35a) of each of the first shoulder lateral grooves 35. It is preferred that the groove width of the inner end portion (35b) is 3% or more and 15% or less of the groove width of the main body portion (35a). The inner end portion (35b) of each of the first shoulder lateral grooves 35 of the present embodiment is configured as a narrow groove portion having a groove width of 1.5 mm or less. Therefore, the amount of air passing through the first shoulder lateral grooves 35 is decreased, thereby, the noise performance is improved.

It is preferred that a length L6 in the tire axial direction of the inner end portion (35b) of each of the first shoulder lateral grooves 35 is smaller than the length L3 in the tire axial direction of the center portion 18 of each of the crown lateral grooves 15 (shown in FIG. 2). Specifically, the length L6 of the inner end portion (35b) is 40% or more and 60% or less of the length L3 of the center portion 18. Thereby, it is possible that the resonance of the noise generated in the crown lateral grooves 15 and the first shoulder lateral grooves 35 is suppressed.

Each of the first shoulder narrow grooves 36 completely crosses the first shoulder land region 13 in the tire axial direction, for example. Each of the first shoulder narrow grooves 36 of the present embodiment is curved so as to be convex to one side in the tire circumferential direction. In a more preferred embodiment, the first shoulder narrow grooves 36 and the first shoulder lateral grooves 35 extend along each other, and an angle difference between them is set to be 5 degrees or less. The first shoulder narrow grooves 36 configured as such can improve the on-snow performance while suppressing the uneven wear in the first shoulder land region 13.

It is preferred that the land ratio of the first shoulder land region 13 is greater than the land ratio of the crown land region 10. Specifically, the land ratio of the first shoulder land region is 75% or more and 85% or less. The first shoulder land region 13 configured as such is helpful for improving the steering stability on dry road surfaces.

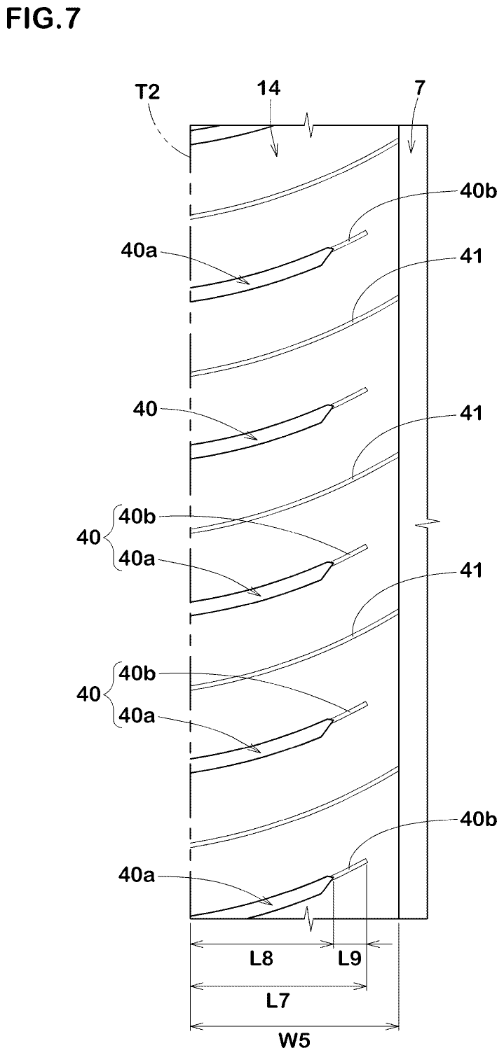

FIG. 7 shows an enlarged view of the second shoulder land region 14. As shown in FIG. 7, the second shoulder land region 14 is provided with second shoulder lateral grooves 40 and second shoulder narrow grooves 41 arranged alternately one by one in tire circumferential direction.

Each of the second shoulder lateral grooves 40 at least extends axially inward from the second tread edge T2 and terminates to have a closed end within the second shoulder land region 14, for example. Each of the second shoulder lateral grooves 40 has an axial length L7 of 75% or more and 90% or less of a width W5 in the tire axial direction of the second shoulder land region 14, for example. Therefore, it is possible that deterioration of the noise performance is suppressed, the deterioration being caused by air escaping from the second shoulder circumferential groove 7 toward the second tread edge T2.

Each of the second shoulder lateral grooves 40 includes a main body portion (40a) arranged on the second tread edge T2 side and an inner end portion (40b) connected with the main body portion (40a) on the axially inner side thereof and having a groove width smaller than the main body portion (40a), for example.

The main body portion (40a) of each of the second shoulder lateral grooves 40 crosses a center position in the tire axial direction of the second shoulder land region 14, for example. The main body portion (40a) has an axial length L8 of 60% or less and 70% or more of the width W5 in the tire axial direction of the second shoulder land region 14, for example. Therefore, the on-snow performance and the noise performance are improved in a good balance.

In each of the second shoulder lateral grooves 40, the inner end portion (40b) extends from the main body portion (40a) and terminates to have a closed end within the second shoulder land region 14. The inner end portion (40b) has an axial length L9 of 15% or more and 25% or less of the width W5 in the tire axial direction of the second shoulder land region 14, for example. In a more preferred embodiment, the length L9 of the inner end portion (40b) is smaller than the length L3 in the tire axial direction of the center portion 18 of each of the crown lateral grooves 15. Thereby, resonance of the noise generated by each of the lateral grooves can be suppressed.

It is preferred that in each of the second shoulder lateral grooves 40, the inner end portion (40b) has a groove width of 3% or more and 15% or less of a groove width of the main body portion (40a). The inner end portion (40b) of each of the second shoulder lateral grooves 40 in the present embodiment is configured as a narrow groove portion having a groove width of 1.5 mm or less. Thereby, excellent steering stability can be obtained.

Each of the second shoulder narrow grooves 41 completely crosses the second shoulder land region 14 in the tire axial direction, for example. In the present embodiment, the second shoulder narrow grooves 41 and the second shoulder lateral grooves 40 extend along each other, and an angle difference between them is set to be 5 degrees or less.

It is preferred that the second shoulder land region 14 has a land ratio larger than the land ratio of the crown land region 10. Specifically, the land ratio of the second shoulder land region is 75% or more and 85% or less. The second shoulder land region 14 configured as such is helpful for improving the on-snow performance and the noise performance in a good balance.

While detailed description has been made of an embodiment of the present disclosure, the present disclosure can be embodied in various forms without being limited to the above-illustrated specific embodiment.

### EXAMPLES

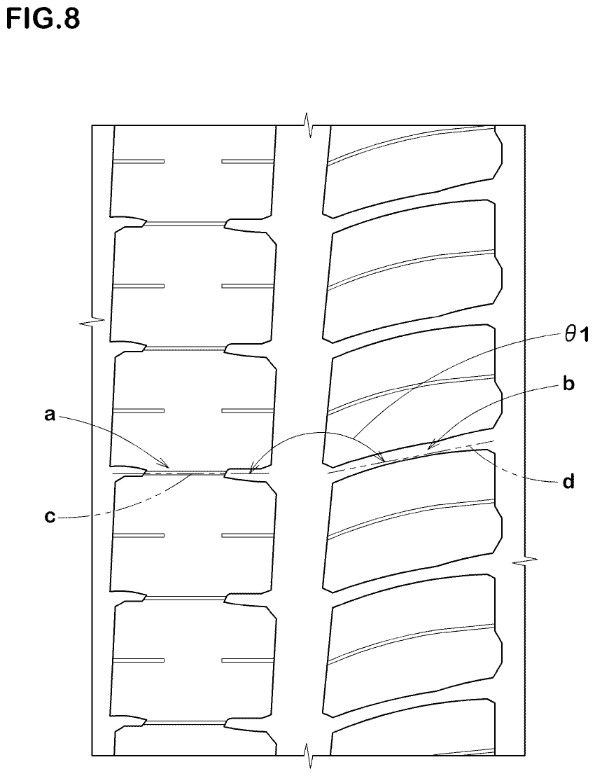

Tires of size 225/65R17 having the pattern shown in FIG. 1 were made by way of test according to the specifications listed in Table 1. As Reference, tires having the crown land region shown in FIG. 8 were made by way of test. As shown in FIG. 8, in each of the tires in Reference, each of crown lateral grooves (a) extends along the tire axial direction, and the angle θ1 between a first linear line (c) connecting both ends of each of the crown lateral grooves (a) and a second linear line (d) connecting both ends of a respective one of first middle lateral grooves (b) is set to be 175 degrees. Each of the tires in the Reference has substantially the same pattern as that shown in FIG. 1, except for the configuration described above. Each of the test tires was tested for the on-snow performance and the noise performance. Common specifications of the test tires and the test methods were as follows.

Tire rim: 17×7.0 JJ

Tire inner pressure: 230 kPa (front wheels), 210 kPa (rear wheels)

Test vehicle: displacement of 2000 cc, 4WD-car

Tire mounting position: all wheels

### <On-Snow Performance>

A coefficient of friction was measured when each of the test tires was run on an inside drum testing machine having snow therein and accelerated from 8 km/h to 35 km/h. The test results are indicated by an index based on the coefficient of friction of the Reference being 100, wherein the larger the numerical value, the better the on-snow performance is.

### <Noise Performance>

While a driver drove the above test vehicle on a dry road surface, the noise performance was evaluated by the driver's senses. The results are indicated by an evaluation point based on the Reference being 100, wherein the larger the numerical value, the better the noise performance is.

The test results are shown in Table 1.

TABLE 1

| | Ref. | Ex. | Ex. | Ex. | Ex. | Ex. | Ex. | Ex. | Ex. | Ex. | Ex. | Ex. |
|---|---|---|---|---|---|---|---|---|---|---|---|---|
| | 1 | 1 | 2 | 3 | 4 | 5 | 6 | 7 | 8 | 9 | 10 | 11 |
| Figure showing Crown land region and | FIG. | FIG. | FIG. | FIG. | FIG. | FIG. | FIG. | FIG. | FIG. | FIG. | FIG. | FIG. |
| First middle land region | 8 | 2 | 2 | 2 | 2 | 2 | 2 | 2 | 2 | 2 | 2 | 2 |
| Angle θ1 between First linear line and | 175 | 130 | 90 | 100 | 110 | 120 | 140 | 150 | 130 | 130 | 130 | 130 |
| Second linear line [degree] | | | | | | | | | | | | |
| Groove width of Center portion/Groove | 15 | 15 | 15 | 15 | 15 | 15 | 15 | 15 | 5 | 10 | 20 | 25 |
| width of First and Second end portions [%] | | | | | | | | | | | | |
| On-snow performance [index] | 100 | 103 | 100 | 101 | 102 | 103 | 102 | 101 | 101 | 102 | 103 | 104 |
| Noise performance [evaluation point] | 100 | 110 | 111 | 111 | 110 | 110 | 108 | 104 | 110 | 110 | 108 | 106 |

As shown in Table 1, it was confirmed that the tires in Examples improved the noise performance while maintaining the on-snow performance.

### [Statement of Disclosure]

The present disclosure includes the following aspects.

### [Present Disclosure 1]

A tire including a tread portion, wherein

the tread portion includes a plurality of circumferential grooves extending continuously in a tire circumferential direction between a first tread edge and a second tread edge, and a plurality of land regions demarcated by the circumferential grooves,

the land regions include a crown land region and a first middle land region adjacent to the crown land region on the first tread edge side with one of the circumferential grooves therebetween,

the crown land region is provided with a plurality of crown lateral grooves inclined to a first side with respect to a tire axial direction and completely cross the crown land region in the tire axial direction,

the first middle land region is provided with a plurality of first middle lateral grooves inclined to a second side opposite to the first side with respect to the tire axial direction and completely cross the first middle land region in the tire axial direction,

in a tread plan view, an angle between a first linear line connecting both ends of each of the crown lateral grooves and a second linear line connecting both ends of a respective one of the first middle lateral grooves is 90 degrees or more and 150 degrees or less,

each of the crown lateral grooves includes a first end portion and a second end portion in the tire axial direction, and a center portion arranged between the first end portion and the second end portion, and

the center portion has a groove width smaller than a groove width of the first end portion and a groove width of the second end portion.

### [Present Disclosure 2]

The tire according to Present disclosure 1, wherein a maximum groove width of the center portion is 15% or less of a maximum groove width of the first end portion and a maximum groove width of the second end portion.

### [Present Disclosure 3]

The tire according to Present disclosure 1 or 2, wherein

the tread portion has a specified position when mounted on a vehicle, and

the first tread edge is positioned on an inner side of the vehicle when mounted thereon.

### [Present Disclosure 4]

The tire according to any one of Present disclosures 1 to 3, wherein the second linear line has an angle with respect to the tire axial direction smaller than an angle of the first linear line with respect to the tire axial direction.

### [Present Disclosure 5]

The tire according to any one of Present disclosures 1 to 4, wherein each of the crown lateral grooves and a respective one of the first middle lateral grooves are adjacent to each other in the tire axial direction, so that, in the tread plan view, each of the first linear lines and a respective one of the second linear lines intersect in one of the circumferential grooves arranged between the crown land region and the first middle land region.

### [Present Disclosure 6]

The tire according to any one of Present disclosures 1 to 5, wherein in a meridian section passing through a tire rotational axis of the tire in a standard state in which the tire is mounted on a standard rim, inflated to a standard inner pressure, and loaded with no tire load, each of a ground contacting surface of the crown land region and a ground contacting surface of the first middle land region has a profile curved so as to be convex outward in a tire radial direction.

### [Present Disclosure 7]

The tire according to any one of Present disclosures 1 to 6, wherein the crown land region had a land ratio of 65% or more and 75% or less.

### [Present Disclosure 8]

The tire according to any one of Present disclosures 1 to 7, wherein

the tread portion includes a first shoulder land region including the first tread edge. and

the first middle land region has a land ratio greater than a land ratio of the crown land region.

### [Present Disclosure 9]

The tire according to any one of Present disclosures 1 to 8, wherein

the tread portion includes a first shoulder land region including the first tread edge. and

the first shoulder land region has a land ratio of 75% or more and 85% or less.

### [Present Disclosure 10]

The tire according to any one of Present disclosures 1 to 9, wherein

the tread portion includes a second shoulder land region including the second tread edge, and

the second shoulder land region is provided with second shoulder lateral grooves at least extending axially inward from the second tread edge and terminating to have closed ends within the second shoulder land region.

### [Present Disclosure 11]

The tire according to Present disclosure 10, wherein each of the second shoulder lateral grooves includes a main body portion arranged on the second tread edge side and an inner end portion connected with the main body portion on an axially inner side thereof and having a groove width smaller than a groove width of the main body portion.

### [Present Disclosure 12]

The tire according to Present disclosure 11, wherein the groove width of the inner end portion is 3% or more and 15% or less of the groove width of the main body portion.

### DESCRIPTION OF REFERENCE SIGNS

2 tread portion
3 circumferential groove
10 crown land region
11 first middle land region
15 crown lateral groove
16 first end portion
17 second end portion
18 center portion
20 first middle lateral groove
21 first linear line
22 second linear line
T1 first tread edge
T2 second tread edge

1. A tire comprising a tread portion, wherein
the tread portion includes a plurality of circumferential grooves extending continuously in a tire circumferential direction between a first tread edge and a second tread edge, and a plurality of land regions demarcated by the circumferential grooves,
the land regions include a crown land region and a first middle land region adjacent to the crown land region on the first tread edge side with one of the circumferential grooves therebetween,
the crown land region is provided with a plurality of crown lateral grooves inclined to a first side with respect to a tire axial direction and completely cross the crown land region in the tire axial direction,
the first middle land region is provided with a plurality of first middle lateral grooves inclined to a second side opposite to the first side with respect to the tire axial direction and completely cross the first middle land region in the tire axial direction,
in a tread plan view, an angle between a first linear line connecting both ends of each of the crown lateral grooves and a second linear line connecting both ends of a respective one of the first middle lateral grooves is 90 degrees or more and 150 degrees or less,
each of the crown lateral grooves includes a first end portion and a second end portion in the tire axial direction, and a center portion arranged between the first end portion and the second end portion, and
the center portion has a groove width smaller than a groove width of the first end portion and a groove width of the second end portion.

2. The tire according to claim 1, wherein a maximum groove width of the center portion is 15% or less of a maximum groove width of the first end portion and a maximum groove width of the second end portion.

3. The tire according to claim 1, wherein
the tread portion has a specified position when mounted on a vehicle, and
the first tread edge is positioned on an inner side of the vehicle when mounted thereon.

4. The tire according to claim 1, wherein the second linear line has an angle with respect to the tire axial direction smaller than an angle of the first linear line with respect to the tire axial direction.

5. The tire according to claim 1, wherein each of the crown lateral grooves and a respective one of the first middle lateral grooves are adjacent to each other in the tire axial direction, so that, in the tread plan view, each of the first linear lines and a respective one of the second linear lines intersect in one of the circumferential grooves arranged between the crown land region and the first middle land region.

6. The tire according to claim 1, wherein in a meridian section passing through a tire rotational axis of the tire in a standard state in which the tire is mounted on a standard rim, inflated to a standard inner pressure, and loaded with no tire load, each of a ground contacting surface of the crown land region and a ground contacting surface of the first middle land region has a profile curved so as to be convex outward in a tire radial direction.

7. The tire according to claim 1, wherein the crown land region had a land ratio of 65% or more and 75% or less.

8. The tire according to claim 1, wherein
the tread portion includes a first shoulder land region including the first tread edge. and
the first middle land region has a land ratio greater than a land ratio of the crown land region.

9. The tire according to claim 1, wherein
the tread portion includes a first shoulder land region including the first tread edge. and
the first shoulder land region has a land ratio of 75% or more and 85% or less.

10. The tire according to claim 1, wherein
the tread portion includes a second shoulder land region including the second tread edge, and
the second shoulder land region is provided with second shoulder lateral grooves at least extending axially inward from the second tread edge and terminating to have closed ends within the second shoulder land region.

11. The tire according to claim 10, wherein each of the second shoulder lateral grooves includes a main body portion arranged on the second tread edge side and an inner end portion connected with the main body portion on an axially inner side thereof and having a groove width smaller than a groove width of the main body portion.

12. The tire according to claim 11, wherein the groove width of the inner end portion is 3% or more and 15% or less of the groove width of the main body portion.

13. The tire according to claim 1, wherein each of an axial length of the first end portion and an axial length of the second end portion is smaller than an axial length of the center portion.

14. The tire according to claim 1, wherein each of an angle of the first end portion and an angle of the second end portion with respect to the tire axial direction is smaller than an angle of the center portion with respect to the tire axial direction.

15. The tire according to claim 1, wherein
the crown lateral grooves are arranged in the tire circumferential direction,
the crown land region is further provided with a first crown narrow groove and a second crown narrow groove both arranged between two crown lateral grooves adjacent to each other in the tire circumferential direction,
the first crown narrow groove extends from one of the circumferential grooves arranged between the crown land region and the first middle land region and terminates to have a closed end within the crown land region, and
the second crown narrow groove extends from one of the circumferential grooves adjacent to the crown land region on a side opposite to the first middle land region and terminates to have a closed end within the crown land region.

16. The tire according to claim 15, wherein the second crown narrow groove terminates on the first middle land region side of the second end portion.

17. The tire according to claim 15, wherein
the first crown narrow groove and the second crown narrow groove are inclined to the first side with respect to the tire axial direction, and
an angle of the first crown narrow groove with respect to the tire axial direction and an angle of the second crown narrow groove with respect to the tire axial direction are each smaller than an angle of the center portion with respect to the tire axial direction.

18. The tire according to claim 1, wherein
each of the first middle lateral grooves is curved so as to be convex toward one side in the tire circumferential direction, and
in each of the first middle lateral grooves, a distance between a groove center line and the second linear line is smaller than a groove width.

19. The tire according to claim 5, wherein
in a pair of one of the crown lateral grooves and one of the first middle lateral grooves adjacent to each other in the tire axial direction, an area obtained by projecting a connection portion parallel to the tire axial direction, said connection portion being between the crown lateral groove of the pair and the one of the circumferential grooves arranged between the crown land region and the first middle land region, overlaps with a connection portion between the first middle lateral groove of the pair and the one of the circumferential grooves arranged between the crown land region and the first middle land region.

20. The tire according to claim 1, wherein
the first middle land region is provided with a plurality of first middle narrow grooves,
the first middle narrow grooves completely cross the first middle land region in the tire axial direction, and
the first middle narrow grooves and the first middle lateral grooves are arranged alternately one by one in the tire circumferential direction.
